(19) United States
(12) Patent Application Publication
(10) Pub. No.: US 2024/0412410 A1
(43) Pub. Date: Dec. 12, 2024

(54) METHOD FOR LOCATING A TRAILER, PROCESSING UNIT, AND VEHICLE

(71) Applicant: ZF CV SYSTEMS GLOBAL GMBH, Bern (CH)

(72) Inventors: Tobias KLINGER, Springe (DE); Ralph-Carsten LUELFING, Garbsen (DE)

(21) Appl. No.: 18/698,364

(22) PCT Filed: Sep. 23, 2022
(86) PCT No.: PCT/EP2022/076556

§ 371 Date: Apr. 4, 2024

(30) Foreign Application Priority Data
Oct. 15, 2021 (DE) 10 2021 126 814.1

(51) Int. Cl. G06T 7/73; G06T 7/13; G06T 7/579; G06T 19/20

(52) U.S. Cl. CPC G06T 7/75; G06T 7/13; G06T 7/579; G06T 19/20; G06T 2207/10028; G06T 2207/30241; G06T 2207/30252; G06T 2219/2004; G06T 2219/2016

(57) ABSTRACT

A method for localizing a trailer in surroundings of a towing vehicle, including reading in at least one single image in which the surroundings of the towing vehicle are imaged in two dimensions and determining a feature representation from the at least one read-in single image using an image processing algorithm. Defined features of the trailer are reproduced in the feature representation. At least one model dataset is read in from a trailer database. In each model dataset a defined trailer model is simulated by a model, and a model orientation and/or a model position and/or a model pose of a respective trailer model is modified from the at least one read-in model dataset for fitting the respective trailer model to the determined feature representation. If the respective trailer model is fitted to the determined feature representation, the trailer orientation, the trailer position, and/or the trailer pose is determined.

### CROSS REFERENCE TO RELATED APPLICATIONS

This application is a U.S. National Phase application under 35 U.S.C. § 371 of International Application No. PCT/EP2022/076556, filed on Sep. 23, 2022, and claims benefit to German Patent Application No. DE 10 2021 126 814.1, filed on Oct. 15, 2021. The International Application was published in German on Apr. 20, 2023 as WO 2023/061732 A1 under PCT Article 21(2).

### FIELD

The invention relates to a method for localizing a trailer, a processing unit for carrying out the method, and a vehicle having the processing unit.

### BACKGROUND

Finding the exact location of a trailer in an area around a towing vehicle is crucial, for example during an approach or coupling operation, to be able to plan an exact trajectory or to estimate an articulation angle between the already coupled trailer and the towing vehicle, e.g. for stability functions. For localizing the trailer, it is necessary to determine a trailer position and/or a trailer orientation, i.e. a trailer pose, of the respective trailer in three-dimensional space, which is conventionally carried out by means of appropriate sensors and/or image processing. For example, provision is made to localize a trailer in space by means of LIDAR sensors or 3D stereo cameras and/or to estimate a trailer position and/or trailer orientation by means of additional planar marker structures (QR codes or Aruco markers) on the trailer. Furthermore, it is known from the prior art how photogrammetric methods can be used with a monocular camera to determine the structure of the scene in 3D by means of the forward or backward movement of a vehicle on which the camera is mounted can be used (so-called Structure from Motion (SfM)).

Documents DE 10 2016 011 324 A1, DE 10 2018 114 730 A1, WO 2018/210990 A1 or DE 10 2017 119 968 A1, for example, describe how to derive a trailer position and a trailer orientation of the respective object or trailer relative to the camera or the towing vehicle by means of image processing. According to these, for example, an articulation angle or a distance can be determined. Also using a mono camera, the trailer pose can be determined by localizing at least three markers, which are preferably applied as flat structures on the trailer, in a captured single image and, with knowledge of the marker positions on the trailer, a transformation matrix is determined from which the trailer pose can be derived.

Detection of an articulation angle using a camera is also described in US 2014 200759 A, wherein a flat marker on the trailer is observed from the towing vehicle over time and the articulation angle is estimated from this. Documents JP 2002 012 172 A, US2014277942A1, US 2008 231 701 A and US 2017106796 A also describe an angle of articulation detection as a function of flat markers. In US 2006 293 800 A, coupling points can carry a marker to facilitate automatic detection. The marker can have a special color, texture, or wave reflection property. In DE 10 2004 025 252 B4 it is further described how to determine the articulation angle by sending radiation from a transmitter to a semicircular or hemispherical reflector and subsequently detecting the radiation reflected from it. DE 103 025 45 A1 also describes the detection of a coupling using an object detection algorithm. EP 3 180 769 B1 also describes how to capture a rear of a trailer using cameras and to recognize traceable features, e.g. an edge or corner, from the image. These are then tracked over time, in particular to infer an articulation angle between the towing vehicle and the trailer.

In US 2018 039 266 A it is described additionally how information of a two-dimensional barcode or QR code can be used. In DE 10 2016 209 418 A1, a QR code can also be scanned with a camera to identify the trailer and to pass trailer parameters on to a reversing assistance system. Alternatively or as a supplement, an RFID reader located on the trailer can scan an RFID transponder which is attached to the towing vehicle, for example in the form of a label. This allows a position of the QR code or RFID transponder to be calculated. Orientation is not determined. WO18060192A1 also provides a solution using radio-based transponders. In DE 10 2006 040 879 B4, RFID elements on the trailer are also used for triangulation while approaching.

In WO 2008064892 A1, an observation element is provided which comprises at least three auxiliary points or measurement points that can be detected by a camera. Geometric considerations are used to determine the coordinates or vectors of the focal points of the auxiliary points and from these, to determine the coordinates of the measuring points relative to the camera or image sensor. An articulation angle can be determined from this.

Disadvantages of the described solutions is that these methods or systems include: they are either very complex to carry out or rely on cost-intensive sensors and markers or similar to be additionally attached, or detection of the markers is not reliably possible under different ambient conditions. For example, flat markers cannot be reliably detected in darkness and/or under extreme or low viewing angles, which means the trailer pose or the articulation angle of the trailer relative to the towing vehicle cannot be reliably determined. Moreover, trailers without such markers cannot be localized.

### SUMMARY

In an embodiment, the present disclosure provides a method for localizing a trailer in surroundings of a towing vehicle, the method comprising reading in at least one single image in which the surroundings of the towing vehicle are imaged in two dimensions and determining a feature representation from the at least one read-in single image using an image processing algorithm, wherein defined features of the trailer to be localized are reproduced in the feature representation. The method further comprises reading in at least one model dataset from a trailer database, wherein in each model dataset a defined trailer model is simulated by a model and modifying a model orientation and/or a model position and/or a model pose of a respective trailer model from the at least one read-in model dataset for fitting the respective trailer model to the determined feature representation. In the event that the respective trailer model is fitted to the determined feature representation, the trailer orientation of the trailer to be localized is determined from the model orientation that is then set and/or the trailer position of the trailer to be localized is determined from the model position that is then set and/or the trailer pose of the trailer to be localized is determined from the model pose that is then set.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a-1b show schematic views of a vehicle;

FIG. 2 shows a flow chart of a method according to an embodiment of the invention;

FIG. 3 shows a detailed view of an object imaged in two single images from a single camera; and

FIG. 4 shows a detail view of the single images captured.

### DETAILED DESCRIPTION

In an embodiment, the invention provides a method with which virtually any trailer can be localized in an environment with little design effort and low expenditure. A processing unit and a vehicle are also provided.

According to an embodiment of the invention, a method is therefore provided for localizing a trailer in the surroundings of a towing vehicle, in particular in a rear space, having at least the following steps:
reading in at least one single image in which the surroundings of the towing vehicle are imaged in two dimensions, i.e. a scene representation in a two-dimensional coordinate system is read in;
determining a feature representation from the at least one read-in single image using an image processing algorithm, wherein defined features of the trailer to be localized are reproduced in the feature representation, i.e. a representation is generated from the two-dimensional scene representation, in which only specific features (spatial character, edges, intensity values, etc.) of the scene are now represented, wherein this representation can be in two-dimensional or three-dimensional form;
reading in at least one model dataset from a trailer database, wherein a defined trailer model is simulated by a model in each model dataset;
modifying a model orientation and/or a model position and/or a model pose of the respective trailer model from the at least one read-in model dataset, to fit the respective trailer model to the determined feature representation,
   wherein in the event that the respective trailer model is substantially fitted to the determined feature representation, allowing fort a tolerance,
the trailer orientation of the trailer to be localized is determined from the model orientation that is then set and/or
the trailer position of the trailer to be localized is determined from the model position that is then set and/or
the trailer pose of the trailer to be localized is determined from the model pose that is then set.

The trailer model that is read in each case is thus essentially brought into alignment by means of a corresponding movement (translation, rotation, optionally scaling) in two or three dimensions with the feature representation generated previously from the scene representation, i.e. both representations are superimposed within a tolerance or as closely as possible. If this has been done, the position and orientation of the trailer model, which are then in place or set, are accordingly adopted for the trailer imaged in the respective individual image. This means that the process advantageously only requires a monocular camera with which the two-dimensional images can be captured, as well as a corresponding image processing algorithm and a database with suitably stored trailer models, from which the trailer position and trailer orientation or the trailer pose can be derived directly from geometric considerations after the fitting operation. Therefore, no additional markers on the respective trailer or complex sensors on the towing vehicle are required, so that flexible use is ensured without the need for a costly retrofit.

According to an embodiment of the invention, a processing unit and a vehicle having such a processing unit are further provided.

According to an embodiment, it is provided that a point cloud representation is determined as the feature representation, wherein the point cloud representation contains a point cloud of a plurality of object points, wherein the object points are assigned to the trailer (and optionally also to other objects) in the surroundings. At least the trailer is thus reproduced in the point cloud representation, preferably by its three-dimensional trailer shape or its three-dimensional character as a defined feature, which subsequently enables a clear identification of the trailer or a comparison with the read-in trailer model. In a point cloud, a number of spatial details or features of the trailer can also be represented.

It is preferably also provided that the point cloud of the point cloud representation is determined using an SfM algorithm, wherein depth information is determined by triangulation to a plurality of object points on the trailer from at least two single images read in using the SfM algorithm and the point cloud is generated from the plurality of object points as a function of the respectively determined depth information. In this way, a three-dimensional feature representation of the trailer can be obtain using only a monocular camera by using the same type of image processing (SfM, Structure from Motion).

In an embodiment it is then preferably provided that a 3D model dataset is read in as the model dataset, wherein the respective trailer model is described in the 3D model dataset in three dimensions by means of model points. As is the case for the feature representation or the point cloud, the trailer model read in is thus provided in three dimensions, so that the fitting can take place in the same (three-dimensional) coordinate system and spatial details can be substantially aligned accordingly. This can then be carried out, for example, in a simple manner by bringing the model points of the respective 3D model dataset into overlap with the object points in the point cloud representation, preferably within a tolerance, to fit the respective trailer model to the determined point cloud representation.

According to an embodiment, it is provided that an edge representation is determined as the feature representation, wherein at least trailer edges are also reproduced in the edge representation as defined features of the trailer to be localized. This embodiment can be used, for example as redundancy or for plausibility checking, as an alternative or in addition to a different embodiment of the feature representation. Accordingly, the imaged trailer edges are treated as features, which subsequently enables a simple way to uniquely identify the trailer or compare it with the trailer model read in.

To this end it is preferably provided that, in particular, the trailer edges of the edge representation are determined using an edge algorithm, e.g. a Canny, Sobel, Prewitt, etc. algorithm, from at least one single image read in. Therefore, a simple image processing can also be used to generate a corresponding edge representation in two dimensions (or three dimensions) from just one (or more) single image(s) captured by a monocular camera, which can then be used for the subsequent localization process. In this process, it is preferably provided that an edge-model dataset is read in as the model dataset, wherein the respective trailer model is described in the edge-model dataset by model edges, which are characteristic for the simulated trailer model. Thus, edges are compared with each other and substantially brought into alignment or overlap to fit the trailer model to the edge representation. The edge-model dataset, like the edge representation, can be in two-dimensional or three-dimensional form, wherein both should preferably have the same dimensionality in order to avoid a coordinate transformation (3D⇔2D).

According to an embodiment, it is provided that an intensity representation is determined as the feature representation, wherein at least trailer intensity values are also reproduced in the intensity representation in a spatially resolved manner as defined features of the trailer to be localized. This embodiment can be used, for example as redundancy or for plausibility checking, as an alternative or in addition to a different embodiment of the feature representation. Thus, at least the intensity values assigned to one or more object points on the trailer are analyzed in the corresponding color space. For example, the trailer intensity values therefore relate to one or more specific color channels, i.e. in the RGB color space Red (R), Green (G), Blue (B), or in the CMYK color space Cyan (C), Magenta (M), Yellow (Y) and the black component (K). In the same way, a color value of the respective hue can also be recorded.

For this purpose, it is preferably provided that an intensity-model dataset is read in as the model dataset, wherein the respective trailer model is described in a spatially resolved manner in the intensity-model dataset by model intensity values, which are characteristic for the simulated trailer model, preferably as a two-dimensional model. Thus, in an embodiment intensity values are compared with one another and essentially brought into alignment or overlap with one another in a spatially resolved manner to fit the trailer model to the intensity representation. Therefore, using the point cloud, the edges and the intensity values, a number of defined features of the trailer to be localized, which can also be simulated by a model, can be used to perform the subsequent fitting in a simple manner.

It is preferably further provided that the simulated trailer model is represented in a scaled form in the respective model dataset, for example by storing the dimensions of the particular simulated trailer model. For example, the scaling in the simulation of the trailer in the respective model dataset is relevant to enabling the trailer to be localized to be more easily found in the respective model dataset based on its size (too small or too large) and also so that its distance from the localized trailer can be better estimated or taken into account. The scaling of the trailer model can be taken into account accordingly during the approach.

It is preferably further provided that the modification of a model orientation and/or a model position and/or a model pose of the respective trailer model is carried out by applying a geometric transformation to the particular model dataset read in. The information stored in the particular model dataset (three-dimensional model points, model edges, model intensity values) is thus “moved”, i.e. translated and/or rotated and/or scaled, while maintaining the shape of the trailer model, by means of a geometric transformation in the corresponding coordinate system, wherein this “movement” can be described by the geometric transformation. As a result, the trailer orientation of the trailer to be localized and/or the trailer position of the trailer to be localized and/or the trailer pose of the trailer to be localized can be subsequently easily determined from the geometric transformation, the application of which fits the respective trailer model to the determined feature representation. Thus, the respective orientation and/or position and/or pose follows from the transformation based on geometrical considerations, in particular including a calibration of the respective camera.

It is preferably further provided that the fitting of the respective trailer model to the determined feature representation is carried out in a series of iteration steps, wherein the model orientation and/or the model position and/or the model pose of the respective trailer model is iteratively modified in the respective iteration steps. To take into account different distances or sizes of the trailer to be localized, the search or the fitting can take place at different resolution levels (known as an image pyramid). Therefore, an iterative process is used to bring the trailer model in the respective model dataset into alignment with the respective feature representation as quickly and easily as possible.

This process preferably provides that the iterative fitting of the respective trailer model to the determined feature representation is terminated when an exit criterion is reached, wherein the exit criterion is satisfied when
an iteration number of iteration steps has been reached and/or
a mean distance between the trailer model of the respective model dataset and the respectively assigned features in the respective feature representation falls below a limit distance. If the exit criterion is satisfied, it is assumed that the trailer model is substantially fitted or matched to the respective feature representation. This allows small deviations to be tolerated so that the iterative process does not extend over too long a time, thus completing the localization more quickly without adversely affecting the accuracy of the method too much, wherein the accuracy can be adjusted by setting the iterative parameters accordingly.

It is preferably also provided that a chassis and/or a platform and/or a coupling are simulated by a model by means of the trailer model of the particular model dataset read in. Therefore, it is not absolutely necessary to simulate the entire trailer in detail, but only distinctive or characteristic features with which a trailer can be uniquely identified. This can reduce the amount of data while still providing an accurate localization that can be used for subsequent operations. For this purpose it can be provided, for example, that an articulation angle of the trailer relative to a towing vehicle and/or a trajectory for the approach of the towing vehicle to the trailer are determined from the determined trailer orientation and/or trailer position and/or trailer pose of the trailer. This provides a flexible deployment based on a less elaborate localization process.

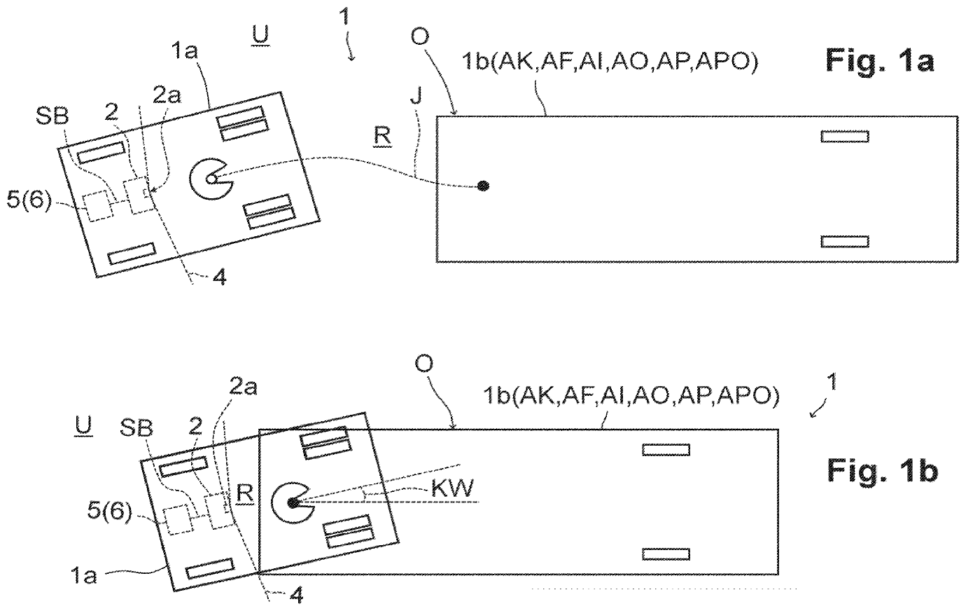

FIG. 1a shows, in a plan view in schematized form, a vehicle 1, which consists of a towing vehicle 1a and a trailer 1b, wherein the trailer 1b in the situation shown is not coupled to the towing vehicle 1a. Using a method according to an embodiment of the invention for localizing the trailer 1b, which is described below, the trailer 1b can be coupled to the towing vehicle 1a by moving the towing vehicle 1a along a fixed trajectory J. Alternatively, the trailer 1b can also be coupled, as shown in FIG. 1b, and using the method according to an embodiment of the invention, for example, an articulation angle KW between the trailer 1b and the towing vehicle 1a can be determined.

To carry out the method for localizing the trailer 1b, a camera system 2 is provided on the towing vehicle 1a, which has at least one camera 2a, in particular of monocular design, with which the surroundings U in particular behind the towing vehicle 1a can be captured. A viewing range 4 of the at least one camera 2a is thus directed in particular to a rear space R behind the towing vehicle 1a. In order to cover the entire, or at least a large, region of the surroundings U, in particular the rear space R, the camera(s) 2a can be designed, for example, as fisheye camera(s) which can cover a viewing range 4 with a viewing angle equal to or greater than 170°.

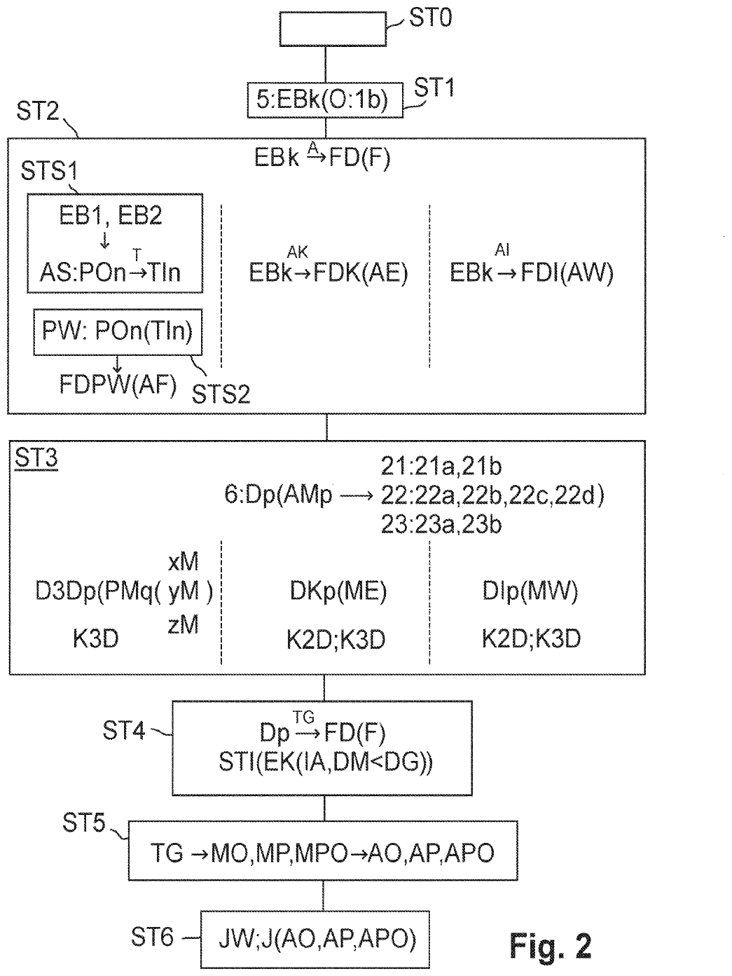

Image signals output by the respective camera 2a SB can be output, optionally after preprocessing, to a processing unit 5, e.g. in the towing vehicle 1a, which is designed to process single images EBk of the respective camera 2a based on the image signals SB, in order to carry out the method for localizing a trailer 1b illustrated by way of example in FIG. 2. For this purpose, after an initialization step ST0, in a first step ST1, one (k=1) or more (k=1, 2, . . . ) single images EBk reproducing the surroundings U of the towing vehicle 1a in two dimensions are read in from the processing unit 5, where the respective trailer 1b to be localized is shown as object O on the single images EBk. The single images EBk therefore contain a 2D representation of the current scene (scene representation in two dimensions).

In a second step ST2, a feature representation FD is then generated from this at least one single image EBk using a selected image processing algorithm A. The feature representation FD is understood to mean a representation in which only fixed or defined features F of the imaged scene are reproduced. The feature representation FD is thus to be understood as a subset of the scene representation, wherein this subset is generated by the respective image processing algorithm A from the at least one single image EBk. As image processing algorithms A for determining or generating a feature representation FD, different exemplary embodiments can be used:

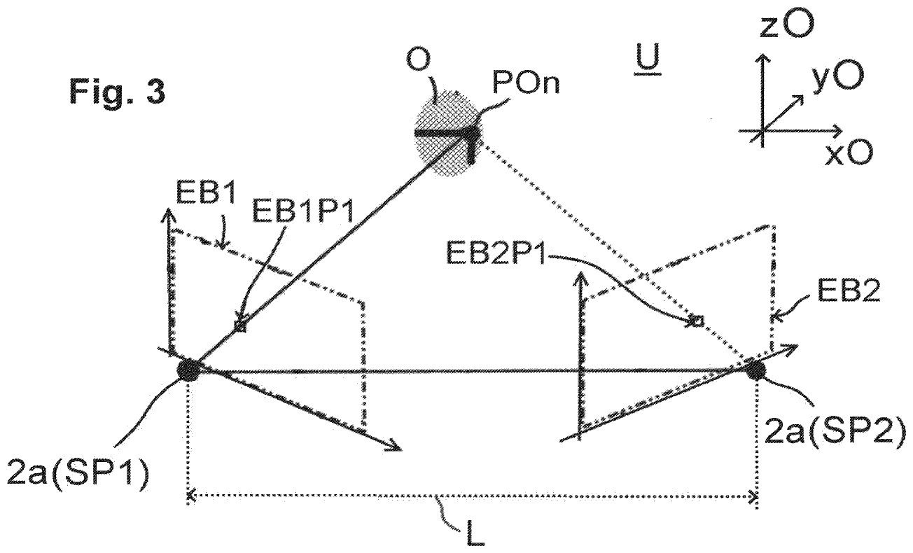

In a first exemplary embodiment, a plurality, i.e. at least two (k=1, 2), single images EBk read in from the same camera 2a are processed by the processing unit 5 using an SfM algorithm AS (SfM: Structure-from-Motion). By means of the SfM algorithm AS, in a first SfM step STS1, from these at least two single images EBk depth information TIn can be obtained for object points POn, either captured or imaged in the single images EBk (see FIG. 3), which are assigned to a specific object O in the surroundings U. The extraction of depth information TIn via the SfM algorithm AS is carried out by capturing an object point POn on the respective object O from at least two different viewpoints SP1, SP2 by the same camera 2a, as indicated in FIG. 3.

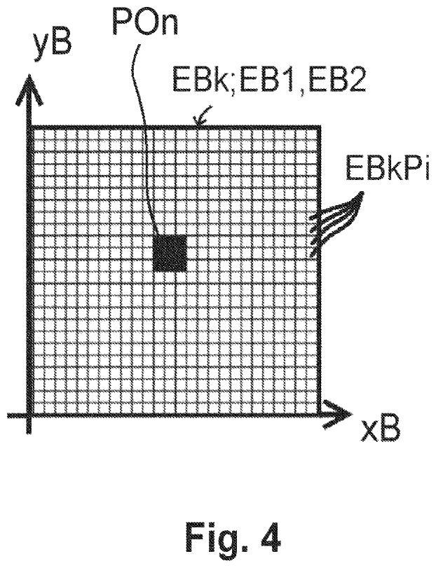

By triangulation T, the depth information TIn with respect to each object point POn captured in pairs can then be obtained. For this purpose, image coordinates xB, yB in a two-dimensional coordinate system K2D (see FIG. 4) are determined for at least one first single-image pixel EB1P1 in a first single image EB1 and for at least one first single-image pixel EB2P1 in a second single image EB2 of the same camera 2a. Both single images EB1, EB2 are captured by the camera 2a at different viewpoints SP1, SP2, i.e. between the single images EB1, EB2, the towing vehicle 1a or the camera 2a is moved by a base length L. The first two single-image pixels EB1P1, EB2P1 are chosen in the respective single images EB1, EB2 in a known manner such that they are assigned to the same object point POn on the respective imaged object O.

In this way, one or more pairs of single-image pixels EB1Pi, EB2Pi for one (n=1) or more (n=1, 2, . . . ) object points POn can be determined for an object O with its object points POn. In an approximation, the absolute, actual object coordinates xO, yO, zO (world coordinates) of the respective object point(s) POn of the three-dimensional object O can be calculated or estimated by triangulation T from the image coordinates xB, yB of the single-image pixels EB1Pi, EB2Pi determined for the respective object O or the object points POn. In order to be able to carry out the triangulation T, a suitably determined base length L between the viewpoints SP1, SP2 of the camera 2a is used, for example obtained from movement data of the towing vehicle 1a and the camera 2a.

If the motion data is not available, it is also possible to determine the movement data by visual odometry, i.e. “visually” from the single images EBk, in the course of the SfM algorithm AS. To do this, the movement of the camera 2a is estimated by means of time-tracked feature points or object points POn from the single images EBk.

If the triangulation T was performed for a sufficient number of object points POn of an object O, in a second SfM step STS2, a three-dimensional point cloud PW of a plurality of object points POn can be generated in actual object coordinates xO, yO, zO (world coordinates) in order to describe the respective object O in three-dimensional space. Since the method according to an embodiment of the invention is to be used to detect and localize a trailer 1b, the SfM algorithm AS also determines at least object points POn and these are represented as a three-dimensional point cloud PW, which are assigned to a trailer 1b as the object O in the surroundings U.

Using the SfM algorithm AS, a point cloud representation FDPW in three-dimensional space is thus generated from the two-dimensional representation of the scene (scene representation in the single images EBk) as a feature representation FD. This point cloud representation FDPW contains at least any object points POn which are located on the imaged trailer 1b to be localized, for example on the side surfaces of the trailer 1b. In the point cloud representation FDPW the three-dimensional character or the three-dimensional trailer shape AF of the imaged trailer 1b to be localized is thus reproduced by the point cloud PW as a defined feature F.

In a third step ST3, which can also be carried out before the second step ST2, one (p=1) or more (p=1, 2, . . . ) stored model datasets Dp are read in from a trailer database 6 by the processing unit 5, wherein a specific trailer model AMp is modeled in each model dataset Dp. The respective trailer model AMp is modeled using the features analyzed in the respective exemplary embodiment F. In the first exemplary embodiment, in which the point cloud representation FDPW generated by means of the SfM algorithm AS is used, a 3D model dataset D3Dp is read in as the model dataset Dp, for example.

In each 3D model dataset D3Dp, at least the three-dimensional character or the three-dimensional shape of the relevant trailer model AMp is simulated by a model. For this purpose, such a 3D model dataset D3Dp contains, for example, a plurality (q=1, 2, . . . ) of model points PMq each with model coordinates xM, yM, zM in a three-dimensional Cartesian coordinate system K3D, wherein the model points PMq spatially describe or characterize the trailer model AMp, preferably in scaled form, to identify and localize the trailer more easily based on its size. Here, only such spatial details can be modeled as are specific to the respective trailer model AMp, for example a chassis 21 and/or a platform 22 and/or a coupling 23 of the respective modeled trailer model AMp.

For example, the respective 3D model dataset D3Dp can indicate whether the respective modeled trailer has a box-shaped platform 22a with or without an additional cooling unit 22b or a silo-shaped platform 22c or a flatbed-type platform 22d, i.e. whether it will be modeled using the 3D model dataset D3Dp by a refrigerated trailer or a normal box trailer or a tank trailer or a flatbed trailer, etc.

In addition or alternatively, the respective 3D model dataset D3Dp can indicate whether the simulated trailer model AMp has a container chassis 21a (without platform) and/or how many vehicle axles 21b are arranged on the chassis 21. In addition, the respective 3D model dataset D3Dp can include whether the modeled trailer model AMp has a tiller coupling 23a (rigid or movable) or a kingpin 23b as the coupling 23.

Depending on the scope of the trailer database 6, different 3D model datasets D3Dp are first read in parallel to each other, since it is yet to be determined which 3D model dataset D3Dp that is read in corresponds to the trailer 1b reproduced by the point cloud representation FDPW. In a fourth step ST4, a check is subsequently carried out to determine whether one of the model datasets Dp or 3D model datasets D3Dp read in can be fitted to the generated point cloud PW from the point cloud representation FDPW. Thus, a model-based alignment is performed in which it is attempted to fit a defined trailer model AMp to the generated point cloud PW.

For this purpose, the trailer model AMp simulated in the respective 3D model dataset D3Dp is scaled by a geometric transformation TG in a series of iteration steps STI and/or “moved” by translation and/or rotation, in such a way that the trailer model AMp essentially corresponds to the point cloud PW which reproduces the three-dimensional trailer shape AF. To take into account different distances or sizes of the trailer 1b to be localized, the search or the fitting can take place at different resolution levels (known as an image pyramid).

In an iterative process, a model position MP and a model orientation MO (cf. model pose MPO) of the respective trailer model AMp is thus successively modified. This can be carried out, for example, by bringing the model points PMq in the respective 3D model dataset D3Dp into overlap with the object points POn in the point cloud representation FDPW, i.e. the model coordinates xM, yM, zM of the model points PMq are iteratively brought into alignment by translation and/or rotation with the object coordinates xO, yO, zO of the object points POn, whereby the modeled shape of the trailer model AMp is preserved and then optionally scaled.

For the iterative process of fitting the trailer model AMp to the point cloud PW an exit or escape criterion EK can be defined, on reaching which the iterative process is terminated. The exit criterion EK can be reached, for example, when a certain number of iterations IA of iteration steps STI has been performed, i.e. the trailer model AMp has been moved to IA different model poses MOP. In addition or alternatively, provision can be made to determine a mean distance DM between the model points PMq describing the trailer model AMp and the object points POn forming the point cloud PW, which are assigned to the trailer 1b to be localized, from the respective coordinates. If this mean distance DM falls below a limit distance DG, the exit criterion EK is satisfied and the iterative process is terminated.

If the iterative process is completed and/or terminated, in a fifth step ST5 the model position MP or the model orientation MO or the model pose MPO of the trailer model AMp can be determined from the geometric transformation TG, which translates and/or rotates and/or scales the trailer model AMp to the point cloud PW. From geometrical considerations and given a corresponding calibration of the camera 2a, i.e. with knowledge of the exact position of the camera 2a in space, the trailer position AP or the trailer orientation AO or the trailer pose APO of the trailer 1b relative to the towing vehicle 1a follows directly. The trailer 1b can therefore be localized in this way.

The trailer pose APO can then be re-used subsequently in a sixth step ST6 for different applications, for example for an automated approach and/or coupling of the trailer 1b along a defined trajectory J, or for determining an articulation angle KW between the trailer 1b and the towing vehicle 1a if the coupling connection already exists. For the determination of the articulation angle KW, a relative movement between the towing vehicle 1a and the trailer 1b is required for the SfM algorithm AS in order to obtain different viewpoints SP1, SP2 of the camera 2a.

According to a second embodiment, an edge representation FDK can be generated from the scene representation or the read-in single images EBk as the feature representation FD, wherein for this purpose, in the second step ST2 trailer edges AE are detected in at least one of the read-in single images EBk by an edge algorithm AK, e.g. a Canny, Sobel, Prewitt, etc. algorithm. The edge representation FDK then also contains at least trailer edges AE as defined features F, which are assigned to the imaged trailer 1b and/or which lie on the respectively imaged trailer 1b and characterize the same. The edge representation FDK is preferably provided in a two-dimensional coordinate system K2D, if only a single image EBk of the camera 2a is read in. Given an appropriate design of the camera 2a and/or the image processing, in principle a three-dimensional edge representation FDK can also be present.

In this exemplary embodiment, in the third step ST3, as the model dataset Dp in which a specific trailer model AMp is modeled, an edge-model dataset DKp is read in, in which, in particular, the model edges ME characteristic for the respective trailer model AMp are represented as features. The model edges ME of the trailer model AMp can be provided either in a two-dimensional coordinate system K2D or in a three-dimensional coordinate system K3D. Also in this exemplary embodiment, only such details can be modeled in the edge-model dataset DKp as are specific to the respective trailer model AMp, for example the model edges ME in the region of the chassis 21 and/or the platform 22 and/or the coupling 23 of the respectively modeled trailer model AMp.

Subsequently, for this exemplary embodiment, in the fourth step ST4 it is checked whether one of the read-in edge-model datasets DKp can be fitted to the detected trailer edges AE from the edge representation FDK. Thus, a model-based alignment is performed in which it is attempted to fit a defined trailer model AMp to the generated edge representation FDK.

For this purpose, the trailer model AMp simulated in the respective edge-model dataset DKp is scaled and/or “moved” by translation and/or rotation in a series of iteration steps STI by a geometric transformation TG, in such a way that the model edges ME of the trailer model AMp substantially correspond to or are brought into overlap with the trailer edges AE from the edge representation FDK. To take into account different distances or sizes of the trailer 1b to be localized, the search or the fitting can take place at different resolution levels (known as an image pyramid). In an iterative process, a model position MP and a model orientation MO (cf. model pose MPO) of the respective trailer model AMp is thus successively modified.

This takes place either in two dimensions or in three dimensions, depending on the coordinate system in which the edge-model dataset DKp and the edge representation FDK are provided. If the two are provided in different dimensions, a coordinate transformation is additionally provided, preferably into a common two-dimensional coordinate system K2D. In this exemplary embodiment, an exit criterion EK can also be defined for the iterative process, for example, exceeding a specified number of iterations IA and/or the mean distance DM between the model intensity values ME and the trailer intensity values AE falling below a specified limit distance DG.

If the iterative process is completed and/or terminated, in a fifth step ST5 the model position MP or the model orientation MO or the model pose MPO of the trailer model AMp can be determined from the geometric transformation TG, which translates and/or rotates and/or scales the model edges ME from the edge model dataset DKp to the trailer edges AE from the trailer model AMp. From geometrical considerations and given a corresponding calibration of the camera 2a, i.e. with knowledge of the exact position of the camera 2a in space, the trailer position AP or the trailer orientation AO or the trailer pose APO of the trailer 1b relative to the towing vehicle 1a follows directly. The trailer 1b can therefore also be localized via this, which can be re-used in the sixth step ST6 for the corresponding application.

According to a third embodiment, from the scene representation or the read-in single images EBk an intensity representation FDI can be generated as a feature representation FD, wherein in the second step ST2 in at least one of the read-in single images EBk by an intensity algorithm AI trailer intensity values AW are detected in a spatially resolved manner, i.e. the intensity values assigned to one or more object points POn on the trailer 1b in the corresponding color space. For example, the trailer intensity values AW therefore relate to one or more specific color channels, i.e. in the RGB color space Red (R), Green (G), Blue (B), or in the CMYK color space Cyan (C), Magenta (M), Yellow (Y) and the black component (K). In the same way, a color value of the respective hue can also be recorded.

The intensity representation FDI then also contains at least trailer intensity values AW, also represented in a spatially resolved manner, as defined features F, which are assigned to the imaged trailer 1b and/or which characterize the respectively imaged trailer 1b. The intensity representation FDI is preferably provided in a two-dimensional coordinate system K2D, if only a single image EBk of the camera 2a is used. Given an appropriate design of the camera 2a and/or the image processing, in principle a three-dimensional intensity representation FDI can also be present.

In this third exemplary embodiment, in the third step ST3, as the model dataset Dp in which a specific trailer model AMp is modeled, an intensity model dataset DIp is read in, in which, in particular, the model intensity values ME characteristic for the respective trailer model AMp are represented in a spatially resolved manner as features. The model intensity values ME of the trailer model AMp can be provided either in a two-dimensional coordinate system K2D or in a three-dimensional coordinate system K3D. In this way, a trailer model AMp can be distinguished or specified based on its coloring.

Subsequently, for this embodiment in the fourth step ST4, it is checked whether one of the read-in intensity model datasets DIp or the model intensity values MW contained therein can be brought into alignment with the detected trailer intensity values AW from the intensity representation FDI. Thus, a model-based alignment is performed in which it is attempted to fit a defined trailer model AMp to the generated intensity representation FDI.

For this purpose, the trailer model AMp modeled in the respective intensity model dataset DIp is scaled and/or “moved” by translation and/or rotation in a series of iteration steps STI by a geometric transformation TG, in such a way that the spatially resolved, model intensity values MW of the trailer model AMp provided substantially correspond or are brought into overlap with the likewise spatially resolved trailer intensity values AW from the intensity representation FDI. To take into account different distances or sizes of the trailer 1b to be localized, the search or the fitting can take place at different resolution levels (known as an image pyramid). In an iterative process, a model position MP and a model orientation MO (cf. model pose MPO) of the respective color “coded” trailer model AMp is thus successively modified.

This takes place either in two dimensions or in three dimensions, depending on the coordinate system in which the intensity model dataset DIp and the intensity representation FDI are provided. If the two are provided in different dimensions, a coordinate transformation is additionally provided, preferably into a common two-dimensional coordinate system K2D. In this exemplary embodiment, an exit criterion EK can also be defined for the iterative process, for example, exceeding a specified number of iterations IA and/or the mean distance DM between the model intensity values MW and the trailer intensity values AW falling (value-wise) below a specified limit distance DG (value-wise).

If the iterative process is completed and/or terminated, in a fifth step ST5 the model position MP or the model orientation MO or the model pose MPO of the trailer model AMp can be determined from the geometric transformation TG, which translates and/or rotates and/or scales the spatially resolved model intensity values MW from the intensity model dataset DIp to the spatially resolved trailer intensity values AW from the trailer model AMp. From geometrical considerations and given a corresponding calibration of the camera 2a, i.e. with knowledge of the exact position of the camera 2a in space, the trailer position AP or the trailer orientation AO or the trailer pose APO of the trailer 1b relative to the towing vehicle 1a follows directly. The trailer 1b can therefore also be localized via this, which can be re-used in the sixth step ST6 for the corresponding application.

All the aforementioned embodiments can be used alternatively or in addition to one another, for example in order to set up redundancies or to carry out a plausibility check. In this way, a trailer 1b can be localized from the same scene representation (single images EBk) using different image processing algorithms A.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS (PART OF THE DESCRIPTION)

1 vehicle
1a towing vehicle
1b trailer
2 camera system
2a camera
4 viewing range of the camera 2a
5 processing unit
6 trailer database
21 chassis
21a container chassis
21b vehicle axles
22 platform
22a box-shaped platform
22b cooling unit
22c silo-shaped platform
22d flatbed platform
23 coupling
23a tiller coupling
23b kingpin
A image processing algorithm
AE trailer edges
AF trailer shape
AI intensity algorithm
AO trailer orientation
AP trailer position
APO trailer pose
AK edge algorithm
AMp p-th trailer model
AS SfM algorithm
AW trailer intensity value
Dp model dataset of the p-th trailer model
D3Dp 3D model dataset of the p-th trailer model
DG limit distance
DIP intensity model dataset of the p-th trailer model
DKp edge model dataset of the p-th trailer model
DM mean distance
EBk k-th single image
EBkPi i-th single image pixel in the k-th image EBk
EK exit criterion
F feature
FD feature representation
FDI intensity representation
FDK edge representation
FDPW point cloud representation
IA iteration count
J trajectory
K2D two-dimensional coordinate system
K3D three-dimensional coordinate system
KW articulation angle
L base length
ME model edges
MO model orientation
MP model position
MPO model pose
MW model intensity value
O object
POn n-th object point
PMq q-th model point
PW point cloud
R rear space
SB image signal
SP1 first viewpoint of the camera 2a
SP2 second viewpoint of the camera 2a
T triangulation
TIn depth information for n-th object point PPn
TG geometric transformation
U surroundings
xB, yB image coordinates
xO, yO, zO object coordinates
xM, yM, zM model coordinates
i, k, n, p, q index
ST0, ST1, ST2, ST3, ST4, ST5, ST6 Steps of the method for localizing the trailer 1b
STI iteration steps for fitting the respective model dataset DP to the respective feature display FD
STS1, STS2 SfM steps for determining the point cloud representation PW via the SfM algorithm AS

1: A method for localizing a trailer in surroundings of a towing vehicle, the method comprising:
reading in at least one single image in which the surroundings of the towing vehicle are imaged in two dimensions;
determining a feature representation from the at least one read-in single image using an image processing algorithm, wherein defined features of the trailer to be localized are reproduced in the feature representation;
reading in at least one model dataset from a trailer database, wherein in each model dataset a defined trailer model is simulated by a model;
modifying a model orientation and/or a model position and/or a model pose of a respective trailer model from the at least one read-in model dataset for fitting the respective trailer model to the determined feature representation, wherein in the event that the respective trailer model is fitted to the determined feature representation,
the trailer orientation of the trailer to be localized is determined from the model orientation that is then set and/or
the trailer position of the trailer to be localized is determined from the model position that is then set and/or
the trailer pose of the trailer to be localized is determined from the model pose that is then set.

2: The method as claimed in claim 1, wherein a point cloud representation is determined as the feature representation, wherein the point cloud representation contains a point cloud of a plurality of object points in the surroundings, wherein at least some of the object points are assigned to the trailer in the surroundings.

3: The method as claimed in claim 2, wherein in the point cloud representation at least the three-dimensional trailer shape of the trailer to be localized is reproduced as a defined feature.

4: The method as claimed in claim 2, wherein the point cloud of the point cloud representation is determined using a Structure from Motion (SfM) algorithm, wherein depth information is determined by triangulation for a plurality of object points in the surroundings from at least two read-in single images using the SfM algorithm and the point cloud is generated from the plurality of object points as a function of the respectively determined depth information.

5: The method as claimed in claim 2, wherein a 3D model dataset is read in as the model dataset, wherein the respective trailer model is described in the 3D model dataset in three dimensions by model points.

6: The method as claimed in claim 5, wherein the model points of the respective 3D model dataset are brought into overlap with the object points in the point cloud representation for fitting the respective trailer model to the determined point cloud representation.

7: The method as claimed in claim 1, wherein an edge representation is determined as the feature representation, wherein at least trailer edges are reproduced in the edge representation as defined features of the trailer to be localized.

8: The method as claimed in claim 7, wherein the trailer edges of the edge representation are determined from at least one read-in single image using an edge algorithm.

9: The method as claimed in claim 7, wherein an edge-model dataset is read in as the model dataset, wherein the respective trailer model is described in the edge-model dataset by model edges which are characteristic for the simulated trailer model.

10: The method as claimed in claim 9, wherein the trailer edges in the determined edge representation and/or the model edges in the read-in edge-model dataset are described two-dimensionally or three-dimensionally.

11: The method as claimed in claim 1, wherein an intensity representation is determined as the feature representation by using an intensity algorithm, wherein in the intensity representation at least trailer intensity values are also reproduced in a spatially resolved manner as defined features of the trailer to be localized.

12: The method as claimed in claim 11, wherein an intensity-model dataset is read in as the model dataset, wherein the respective trailer model is described in the intensity-model dataset in a spatially resolved manner, by model intensity values which are characteristic for the simulated trailer model.

13: The method as claimed in claim 1, wherein the simulated trailer model is represented in the at least one model dataset in scaled form.

14: The method as claimed in claim 1, wherein the modification of a model orientation and/or a model position and/or a model pose of the respective trailer model is carried out by applying a geometric transformation to a particular model dataset of the at least one model datasets read in.

15: The method as claimed in claim 14, wherein the trailer orientation of the trailer to be localized and/or the trailer position of the trailer to be localized and/or the trailer pose of the trailer to be localized are determined from the geometric transformation, the application of which fits the respective trailer model to the determined feature representation.

16: The method as claimed in claim 1, wherein the fitting of the respective trailer model- to the determined feature representation is carried out in a series of iteration steps, wherein the model orientation and/or the model position and/or the model pose of the respective trailer model is iteratively modified in the iteration steps.

17: The method as claimed in claim 16, wherein the iterative fitting of the respective trailer model to the determined feature representation is terminated when an exit criterion is reached, wherein the exit criterion is satisfied when
an iteration number of iteration steps has been reached and/or
a mean distance between the trailer model of the respective model dataset and the respectively assigned features in the respective feature representation falls below a limit distance.

18: The method as claimed in claim 1, wherein a chassis and/or a platform and/or a coupling are simulated as a model by the trailer model of the particular model dataset read in.

19: The method as claimed in claim 1, wherein an articulation angle of the trailer relative to the towing vehicle and/or a trajectory for an approach of the towing vehicle to the trailer are determined from the determined trailer orientation and/or trailer position and/or trailer pose of the trailer.

20: A processing unit for a vehicle for carrying out the method as claimed in claim 1, wherein the processing unit is configured to:
read in at least one single image in which the surroundings of a towing vehicle are imaged in two dimensions;
determine a feature representation from the at least one read-in single image using an image processing algorithm, wherein defined features of a trailer to be localized are reproduced in the feature representation;
read in at least one model dataset from a trailer database, wherein a defined trailer model is simulated by a model in each model dataset;
modify a model orientation and/or a model position and/or a model pose of the respective trailer model from the at least one read-in model dataset, and fit the respective trailer model to the determined feature representation,
wherein the processing unit is configured, in the event that the respective trailer model is fitted to the determined feature representation, to determine
the trailer orientation of the trailer to be localized from the model orientation that is then set and/or
the trailer position of the trailer to be localized from the model position that is then set and/or
the trailer pose of the trailer to be localized from the model pose that is then set.

21: A vehicle comprising the processing unit as claimed in claim 20.
